(19) United States
(12) Patent Application Publication
(10) Pub. No.: US 2003/0115330 A1
(43) Pub. Date: Jun. 19, 2003

(54) RECORDING MEDIUM, TRANSMISSION MEDIUM, INFORMATION PROCESSING APPARATUS/INFORMATION PROCESSING METHOD, INFORMATION PROVIDING APPARATUS AND INFORMATION PROCESSING SYSTEM

(76) Inventor: ITARU KAWAKAMI, KANAGAWA (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 08/978,490

(22) Filed: Nov. 25, 1997

(30) Foreign Application Priority Data
Nov. 28, 1996 (JP) P08-317311

(51) Int. Cl. G06F 15/16

(52) U.S. Cl. 709/227

(57) ABSTRACT

It is an object of the present invention to allow an access to a communication apparatus other than a WWW server to be made from a WWW browser in a WWW system.

On a home page controlled by an IP server, if necessary, in addition to an <A> tag for specifying the URL of information in a link destination, a telephone-number tag can also be used for specifying a telephone number assigned to equipment such as a computer capable of carrying out communication only in a predetermined protocol, a FAX-information providing apparatus, a telephone set, a host computer of PC communication and a voice-mail handling apparatus which is described as a destination link. To put it in detail, the telephone-number tag, a new tag type, is added to the HTML to give an extended HTML so that a telephone number can be specified as a link destination, allowing a link to a string of characters and an image to be prescribed. In this way, by using a telephone-number tag, equipment such as the computer, the FAX-information providing apparatus, the telephone set, the host computer of PC communication and the voice-mail handling apparatus can be specified as a link destination.

### BACKGROUND OF THE INVENTION

In general, the present invention relates to a recording medium, a transmission medium, an information processing apparatus as well as its information processing method, an information providing apparatus and an information processing system. In particular, the present invention relates to a good recording medium, a good transmission medium, a good information processing apparatus as well as its information processing method, a good information providing apparatus and a good information processing system typically using a WWW (World Wide Web) system constructed in the Internet.

A WWW system has been constructed in the Internet which has been growing rapidly in recent years. In this WWW system, data is transferred by using a protocol known as a HTTP (Hyper Text Transfer Protocol). In addition, by describing a screen, that is, a home page, by using an HTML (Hyper Text Markup Language), desired information can be searched for and displayed with ease.

In the WWW system, applications can be classified into user-side applications or WWW browsers and information-provider-side applications or WWW servers. Examples of the user-side applications are Netscape Navigator (a trademark) provided by Netscape Corporation, Mosaic (a trademark) provided by NCSA and Internet Explorer (a trademark) provided by Microsoft. On the other hand, examples of the information-provider-side applications includes Netscape Commerce Server (a trademark) provided by Netscape Corporation. A user can make an access to a WWW server for information and a service provided by the server by means of a WWW browser. On the other hand, an information provider can provide information and services to WWW browsers by means of a WWW server.

A WWW server stores text files described in the HTML and transmits a text file requested by a WWW browser to the requesting browser. The WWW browser receives the text file from the WWW server, interprets the contents of the text file and displays a result of the interpretation on a screen. It should be noted that a relation among pieces of video and audio data can be set in advance in an HTML file. In this case, an image (strictly speaking, an inline image) can also be displayed in addition to a text.

By the way, the HTML is a language for describing the structure of a document. An HTML file contains contents described in the HTML and tags. A tag is enclosed by ‘<’ and ‘>’. Typically, a tag is used for expressing, among other things, an element of a document, a structure, a method of formation and a link destination.

For example, in order to indicate that the contents of a file are described in the HTML, <HTML> tags are used. In addition, in order to indicate a paragraph, for instance, <P> tags are used. For example, in order to indicate a link destination, <A> tags are used. Furthermore, in order to specify an image file, for instance, <IMG> tags are used.

In the WWW system, a kind of address known as a URL (Uniform Resource Locator) is used for specifying a file (that is, a home page) located in the Internet. A URL comprises a scheme name, a domain name (or a host name) and a file name which are used for specifying the name of a transfer protocol, the name of a WWW server and the name of a file respectively. For example, consider a URL htt p://www.sony.co.jp/sonydrive/index.html. In this case, the scheme name is http, the domain name is www.sony.co.jp and the file name is sonydrive/index.html. It should be noted that, in an actual access to a server, an IP address is used. An IP address is recognized from a domain name. To put it in detail, there is a DNS (Domain Name Server) which functions as a server for acquiring an IP address from a domain name. A WWW browser makes an inquiry to the DNS in order to recognize an IP address.

As described above, in an HTML file composing a home page, <A> tags are used for indicating a link destination for allowing the user to change from the current home page to another home page relevant to or linked to the current home page with ease.

For example, in an HTML file, the following statement is described:

Go back to <A HREF=“http://www.sony.co.jp/”> Main Menu </A> (1)

In this case, the following message is displayed on the WWW browser:

Go back to Main Menu (2)

In the statement (1), the phrase HREF=“htt p://www.sony.co.jp/”, inside the <A> tag indicates that the URL of a link destination is http://www.sony.co.jp/. In the statement (1), the </A> tag at the end of the statement is a counterpart tag of the <A> tag, a tag for ending the statement indicating a link destination. In some WWW browsers, in order to show that a text sandwiched by a <A> tag and a </A> tag is a link destination, that is, in order to show the text Main Menu in the case of this example is a link destination, the text is displayed as a high light or displayed by putting an under-line beneath it.

If the user clicks the text sandwiched by the <A> tag and the </A> tag, that is the text ‘Main Menu’, after the message (2) “Go back to Main Menu” has been displayed on the WWW browser, the WWW browser makes a request to a WWW server for an HTML file represented by the link destination described inside the <A> tag, that is, the URL http://www.sony.co.jp/ in the case of this example.

The WWW server, to which the domain name of the URL is assigned, searches a data base stored typically in an external storage apparatus for the requested HTML file which is then transmitted to the requesting WWW browser. Receiving the HTML file, the WWW browser interprets the contents thereof and displays a result of the interpretation.

In this way, if a link destination is specified in a predetermined portion of a home page displayed by using an <A> tag, the user can obtain a home page associated with the link destination by clicking the predetermined portion as described above. It should be noted that, in the case described above, a string of characters ‘Main Menu’ is specified as a link destination. It should be noted that another item such as an image can also be specified as a link destination.

By the way, activities such as an online shopping are carried out by using a WWW system in recent years. In such an online shopping, the user typically looks at the picture and the price of a commodity as well as other information on the commodity (or the so-called commodity information) put on a home page displayed on a WWW browser, making a decision as to whether to buy or not to buy the commodity. If a decision to buy the commodity is made, the user enters information identifying the commodity such as the name of the commodity and a unique number assigned to the commodity and, if necessary, the number of commodities to be ordered as well as the so-called commodity related information via the WWW browser. The commodity related information is information such the color, the design and the size of each of the commodities. These pieces of information are then transmitted online to a WWW server or an information provider that provides the commodity information. Then, on a later date, when the payment of the commodity is made through a bank account specified by the user or made by a credit-card company through the use of a credit card, the commodity is delivered to the user.

In an online shopping such as the one described above, the number of a bank account owned by the user or the number of the user's credit card which is required for the payment of a purchased commodity may be transmitted to the WWW server providing the commodity information by using a WWW system or the Internet. In this case, the number of a bank account owned by the user or the number of the user's credit card, which must not be disclosed to others, may be transmitted to the WWW server providing the commodity information by way of some other servers. Transmitting information undisclosable to others, which may be referred to hereafter simply as secret information according to circumstances, raises a security problem.

That is to say, tapping transmitted secret information from lines, mainly dedicated lines, connecting servers constituting the Internet is considered to be basically illegal. In a structure such as a building where a server is installed, however, tapping secret information from a line between the server and an MDF (Main Distribution Frame) or an IDF (Intermediate Distributing Frame) in the building is not considered to be illegal. It should be noted that a line between the server and an MDF (Main Distribution Frame) or an IDF (Intermediate Distributing Frame) in the building may be referred to hereafter as an unregulated segment according to circumstances. Thus, tapping secret information on such an unregulated segment, that is, a line beyond the domain of a law, is an act which may be done without violating the law.

For the reason described above, it is thus not desirable from the security-assurance point of view to transmit secret information to a destination by way of some servers, between which an unregulated segment exists.

When a home page is requested from a WWW browser, on the other hand, it is impossible to know what route in the Internet an HTML file of the requested home page will be transmitted to the requesting WWW browser.

As a result, when an HTML file requested by a user is transmitted through a route which is also used for exchanging a large amount of other information, the communication speed substantially decreases, taking a long time to display a home page of the HTML file. In consequence, the user feels troublesome.

In addition, with the present technology, a link destination is specified by using a URL in an HTML file as described above. In the case of a link destination specified by a URL as described above, a communication apparatus, which is capable of carrying out communication only in a protocol other than a transfer protocol for the URL such as the http or the ftp, can not be specified as a link destination. It will be more convenient, however, if information can be exchanged also with a link destination served by such a communication apparatus or, to put it concretely, a communication apparatus like, for example, a facsimile machine, a telephone set and a computer capable of carrying out communication only in a specific protocol.

### SUMMARY OF THE INVENTION

The present invention addresses the problems described above. It is thus an object of the present invention to provide an information processing system including an information processing apparatus capable of exchanging information with a variety of apparatuses by maintaining the communication speed and assuring information security to a certain degree.

In order to achieve the object described above, the present invention provides a recording medium, a transmission medium, an information processing apparatus, an information processing method, an information providing apparatus and an information processing system which are described briefly as follows.

In accordance with one aspect of the present invention, there is provided a recording medium characterized in that information stored therein includes a line number assigned to a line connected to a predetermined apparatus as a link destination.

According to another aspect of the present invention, there is provided a transmission medium characterized in that information transmitted through the medium includes a line number assigned to a line connected to a predetermined apparatus as a link destination.

According to a further aspect of the present invention, there is provided an information processing apparatus comprising a communication control means which is used for establishing a communication link with a predetermined apparatus based on a line number assigned to a line connected to the predetermined apparatus if a predetermined position specified by operating a command operation means is associated with the line number.

According to a still further aspect of the present invention, there is provided an information processing method comprising a step of processing which is carried out for establishing a communication link with a predetermined apparatus based on a line number assigned to a line connected to the predetermined apparatus if a predetermined position on displayed information is indicated and the predetermined position is associated with the line number.

According to a yet further aspect of the present invention, there is provided a recording medium characterized in that the recording medium is used for storing a computer program comprising a step of processing which is carried out for establishing a communication link connecting an information processing apparatus to a predetermined apparatus based on a line number assigned to a line connected to the predetermined apparatus if a predetermined position on displayed information is indicated and the predetermined position is associated with the line number.

According to a yet further aspect of the present invention, there is provided a transmission medium characterized in that the transmission medium is used for transmitting a computer program comprising a step of processing which is carried out for establishing a communication link connecting said information processing apparatus to a predetermined apparatus based on a line number assigned to a line connected to the predetermined apparatus if a predetermined position on displayed information is indicated and the predetermined position is associated with the line number.

According to a yet further aspect of the present invention, there is provided an information providing apparatus characterized in that information stored in a recording medium includes a line number assigned to a line connected to a predetermined apparatus as a link destination.

According to a yet further aspect of the present invention, there is provided an information processing system characterized in that:

an information providing apparatus thereof includes a recording medium for storing information including a line number assigned to a line connected to a predetermined apparatus as a link destination; and

an information processing apparatus includes a communication control means which is used for establishing a communication link connecting the information processing apparatus to a predetermined apparatus based on a line number assigned to a line connected to the predetermined apparatus if a predetermined position specified by operating a command operation means is associated with the line number.

Information stored in the recording medium includes a line number assigned to a line connected to a predetermined apparatus as a link destination.

Information transmitted through the transmission medium includes a line number assigned to a line connected to a predetermined apparatus as a link destination.

In the information processing apparatus, a communication control means is used for establishing a communication link with a predetermined apparatus based on a line number assigned to a line connected to the predetermined apparatus if a predetermined position specified by operating a command operation means is associated with the line number.

The information processing method comprises a step of processing which is carried out for establishing a communication link with a predetermined apparatus based on a line number assigned to a line connected to the predetermined apparatus if a predetermined position on displayed information is indicated and the predetermined position is associated with the line number.

The recording medium is used for storing a computer program comprising a step of processing which is carried out for establishing a communication link connecting an information processing apparatus to a predetermined apparatus based on a line number assigned to a line connected to the predetermined apparatus if a predetermined position on displayed information is indicated and the predetermined position is associated with the line number.

The transmission medium is used for transmitting a computer program comprising a step of processing which is carried out for establishing a communication link connecting an information processing apparatus to a predetermined apparatus based on a line number assigned to a line connected to the predetermined apparatus if a predetermined position on displayed information is indicated and the predetermined position is associated with the line number.

In the information providing apparatus, information stored in a recording medium includes a line number assigned to a line connected to a predetermined apparatus as a link destination.

In the information processing system, a recording medium is used for storing information including a line number assigned to a line connected to a predetermined apparatus as a link destination and a communication control means is used for establishing a communication link connecting an information processing apparatus to a predetermined apparatus based on a line number assigned to a line connected to the predetermined apparatus if a predetermined position specified by operating a command operation means is associated with the line number.

### BRIEF DESCRIPTION OF THE DRAWINGS

Embodiments of the present invention will be described by referring to the following drawings wherein:

FIG. 1 is a diagram showing the configuration of an embodiment implementing a network system to which the present invention is applied;

FIG. 2 is a diagram showing a typical configuration of a PC 1 shown in FIG. 1;

FIG. 3 shows a flowchart used for explaining processing carried out by the PC 1 shown in FIG. 2;

FIG. 4 is a diagram showing a display example of an input/output unit 14 shown in FIG. 2;

FIG. 5 is a diagram showing another display example of the input/output unit 14 shown in FIG. 2;

FIG. 6 shows a flowchart representing details of the communication processing carried out at a step S16 of the flowchart shown in FIG. 3;

FIG. 7 shows a flowchart representing details of the communication processing carried out at a step S28 of the flowchart shown in FIG. 6;

FIG. 8 shows a flowchart representing details of the communication processing carried out at a step S29 of the flowchart shown in FIG. 6;

FIG. 9 shows a flowchart representing details of the communication processing carried out at a step S30 of the flowchart shown in FIG. 6;

FIG. 10 shows a flowchart representing details of the communication processing carried out at a step S31 of the flowchart shown in FIG. 6;

FIG. 11 shows a flowchart representing details of the communication processing carried out at a step S32 of the flowchart shown in FIG. 6;

FIG. 12 shows a flowchart representing details of the communication processing carried out at a step S33 of the flowchart shown in FIG. 6;

FIG. 13 is a diagram showing a typical configuration of an IP server 5 shown in FIG. 1; and

FIG. 14 shows a flowchart used for explaining processing carried out by the IP server 5 shown in FIG. 13.

### DETAILED DESCRIPTION OF THE PREFERRED EMBODIMENTS

The present invention will become more apparent from a careful study of the following detailed description of some preferred embodiments with reference to accompanying diagrams showing the embodiments. Before explaining the embodiments, it is necessary to clarify relations associating means and method steps cited in the claims described in the present specification with the embodiments in the following description by adding a phrase enclosed in parentheses after each of the means and the method steps. The phrase exemplifies a means and a step by specifying a component employed in an embodiment to implement the means and a processing step in a flowchart to implement the method step respectively.

The information processing apparatus described in claim 7 is an information processing apparatus for processing incoming information described in a language usable for describing a link destination, the apparatus characterized by comprising:

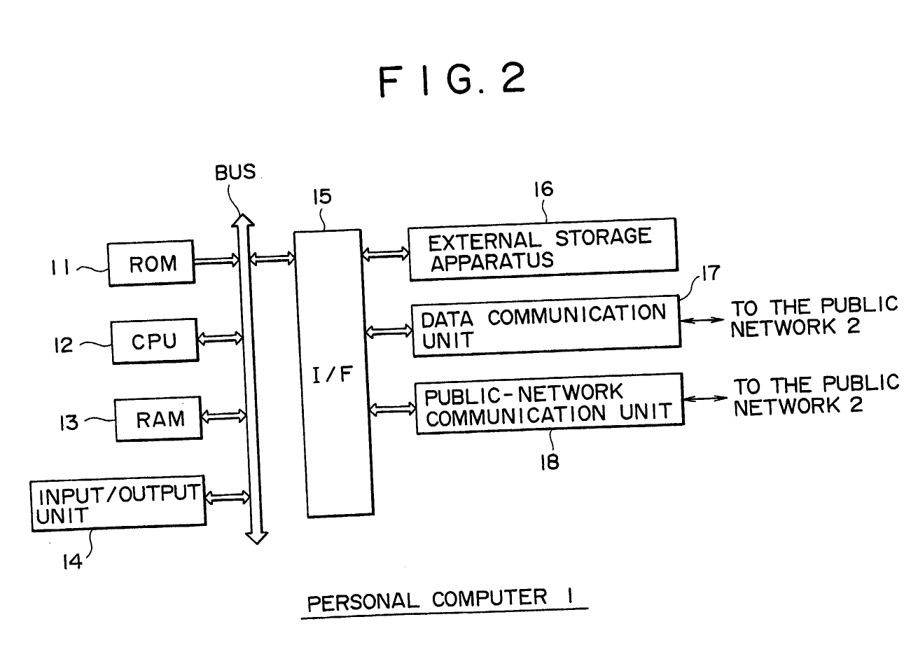

a receiving means (implemented for example by a data communication unit 17 shown in FIG. 2) for receiving the information transmitted by an information providing apparatus for providing the information;

a display means (implemented for example by an input/output unit 14 shown in FIG. 2) for displaying the information received by the receiving means;

a command operation means (implemented for example by the input/output unit 14 shown in FIG. 2) to be operated when specifying a predetermined position in the information displayed by the display means; and

a communication control means (implemented for example by a public-network communication unit 18 shown in FIG. 2) which is used for establishing a communication link with a predetermined apparatus based on a line number assigned to a line connected to the predetermined apparatus if the predetermined position specified by operating the command operation means is associated with the line number.

An information processing apparatus described in claim 8 is characterized in that:

the information is described in an HTML (Hyper Text Markup Language);

the line number is described along with a line-number tag, a tag for showing that what is described thereby is a line number; and

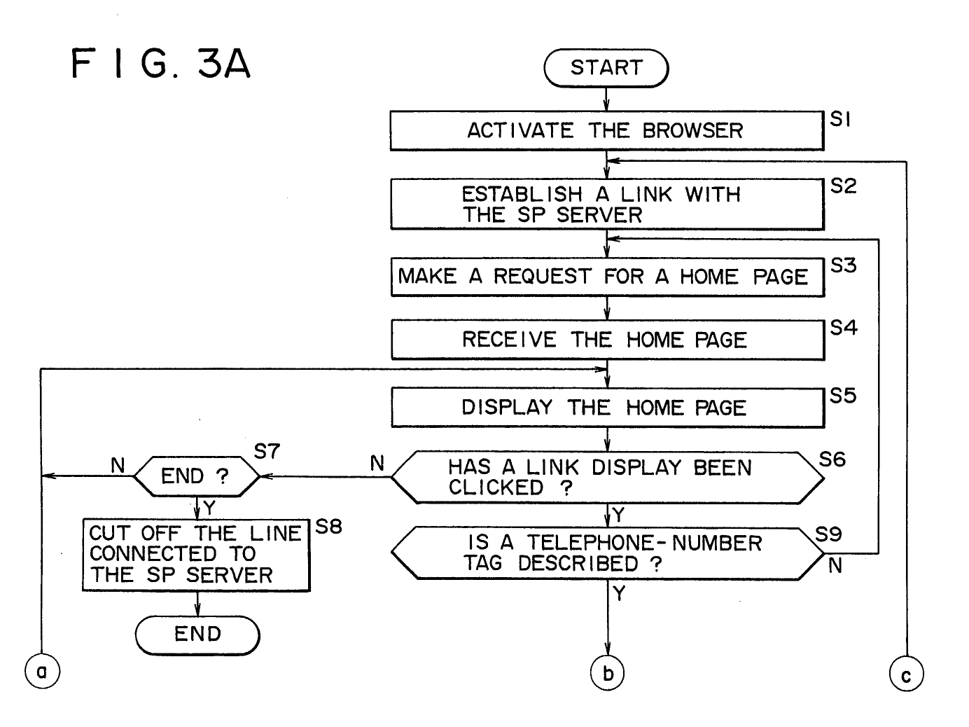

a recognition means (implemented for example by a CPU 12 shown in FIG. 2 and a processing step S9 of a program flowchart shown in FIG. 3) is employed thereby for forming a judgment as to whether or not the line number is associated with the predetermined position based on the line-number tag.

An information processing apparatus described in claim 10 is characterized in that the apparatus includes a line-number selecting means (implemented for example by the CPU 12 shown in FIG. 2 and a processing step S11 of the program flowchart shown in FIG. 3) which is used for selecting one from a plurality of line numbers in case the line numbers are associated with the predetermined position.

An information processing apparatus described in claim 11 is characterized in that the apparatus includes a number adding means (implemented for example by the CPU 12 shown in FIG. 2 and a processing step S15 of the program flowchart shown in FIG. 3) which is used for adding a number required for international communication to a line number in case the line number is a line number of a foreign country.

An information processing apparatus described in claim 12 is characterized in that the apparatus includes a confirmation operating means (implemented for example by the input/output unit 14 shown in FIG. 2) to be operated for confirming that a communication link with the predetermined apparatus should be established.

The recording medium described in claim 18 is a recording medium for storing a computer program to be executed by an information processing apparatus for processing incoming information described in a language usable for describing a link destination, the program characterized by comprising:

the step of receiving and displaying the information transmitted by an information providing apparatus for providing the information (implemented for example by processing steps S4 and S5 of the program flowchart shown in FIG. 3); and

the step of establishing a communication link connecting the information processing apparatus to a predetermined apparatus based on a line number assigned to a line connected to the predetermined apparatus (implemented for example by a processing step S16 of the program flowchart shown in FIG. 3) if a predetermined position on the displayed information is indicated and the predetermined position is associated with the line number.

The recording medium described in claim 19 is a transmission medium for transmitting a computer program to be executed by an information processing apparatus for processing incoming information described in a language usable for describing a link destination, the program characterized by comprising:

the step of receiving and displaying the information transmitted by an information providing apparatus for providing the information (implemented for example by the processing steps S4 and S5 of the program flowchart shown in FIG. 3); and

the step of establishing a communication link connecting the information processing apparatus to a predetermined apparatus based on a line number assigned to a line connected to the predetermined apparatus (implemented for example by the processing step S16 of the program flowchart shown in FIG. 3) if a predetermined position on the displayed information is indicated and the predetermined position is associated with the line number.

An information providing apparatus described in claim 20 comprises:

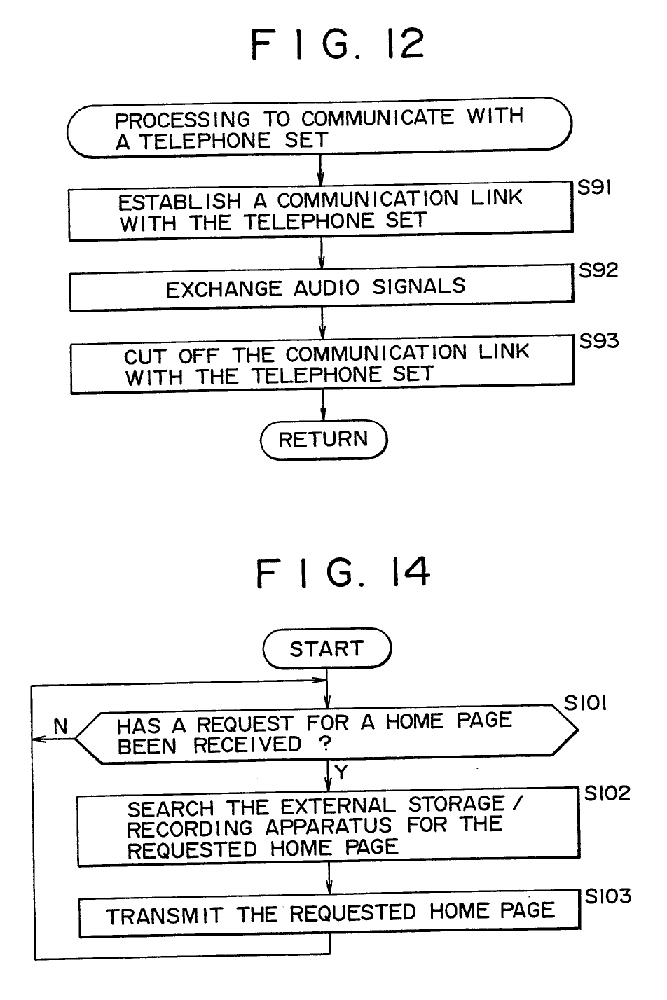

a recording medium (implemented for example by an external storage/recording apparatus 66 shown in FIG. 13) for storing information described in a language usable for describing a link destination; and

a transmitting means (implemented for example by a data communication unit 67 shown in FIG. 13) for transmitting the information in response to a request,

the information providing apparatus characterized in that the information stored in the recording medium includes a line number assigned to a line connected to a predetermined apparatus as the link destination.

An information processing system described in claim 23 comprises an information providing apparatus for providing information described in a language usable for describing a link destination and an information processing apparatus for receiving and processing the information, the system characterized in that:

the information providing apparatus comprises:

a recording medium (implemented for example by the external storage/recording apparatus 66 shown in FIG. 13) for storing information including a line number assigned to a line connected to a predetermined apparatus as the link destination; and

a transmitting means (implemented for example by the data communication unit 67 shown in FIG. 13) for transmitting the information in response to a request received from the information processing apparatus,

whereas the information processing apparatus comprises:

a receiving means (implemented for example by the data communication unit 17 shown in FIG. 2) for receiving the information transmitted by the information providing means;

a display means (implemented for example by the input/output unit 14 shown in FIG. 2) for displaying the information received by the receiving means;

a command operation means (implemented for example by the input/output unit 14 shown in FIG. 2) to be operated when specifying a predetermined position in the information displayed by the display means; and

a communication control means (implemented for example by the public-network communication unit 18 shown in FIG. 2) which is used for establishing a communication link connecting the information processing apparatus to a predetermined apparatus based on a line number assigned to a line connected to the predetermined apparatus if the predetermined position specified by operating the command operation means is associated with the line number.

Of course, each phrase enclosed in parentheses is not intended to be construed in a limiting sense. That is to say, a means or a step is not limited to a typical component or a typical processing step described in the phrase.

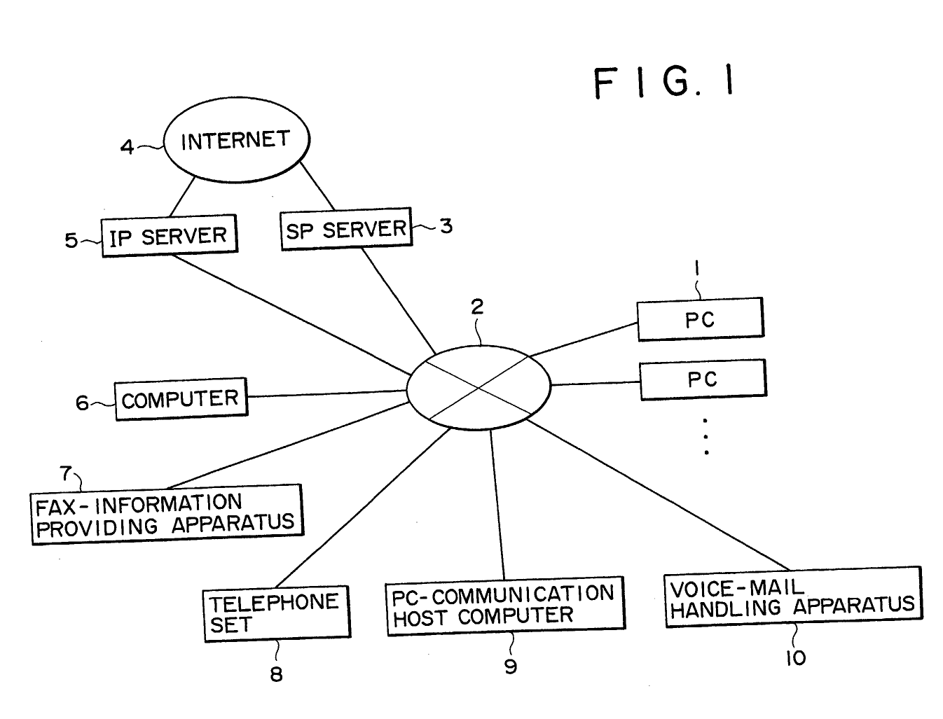

FIG. 1 is a diagram showing the configuration of an embodiment implementing a network system to which the present invention is applied.

As shown in the figure, the user owns a personal computer (referred to hereafter as a PC according to circumstances) 1 which is used as an information processing apparatus. The PC 1 is connected to an SP (Service Provider) server 3 owned by a service provider through a public network 2 such as a PSTN (Public Switched Telephone Network) or an ISDN (Integrated Service Digital Network) or through a dedicated line which is not shown in the figure. PCs owned by other users are each connected to the SP server 3 in the same way as the PC 1.

It should be noted that, in the present embodiment, the PC 1 is connected not only to the SP server 3, but also to equipment such as an IP (Information Provider) server 5, a computer 6 capable of carrying out communication only in a predetermined protocol such as the ftp or the telnet protocol, a FAX-information providing apparatus 7 for providing various kinds of FAX information such as detailed information on a room layout of a building or a house introduced in a real-estate magazine in a format receivable by a facsimile machine, a telephone set (including a portable/pocket telephone) 8, a host computer 9 of the so-called PC communication and a voice-mail handling apparatus 10 for holding and forwarding a spoken message or a voice mail through the public network 2.

The SP server 3 is connected to the Internet 4, a kind of transmission media. In other words, the SP server 3 is one of elements composing the Internet 4. Also connected to the Internet 4 is an information provide's IP server 5 which is also used as a WWW server. The Internet 4 allows computers connected thereto to carry out communication with each other by using a protocol known as a TCP/IP (Transmission Control Protocol/Internet Protocol).

In addition, a WWW system is constructed on the Internet 4 as described earlier. Thus, each user is also capable of making an access to the IP server 5 in addition to the SP server 3 which each serve as a WWW server by using a WWW browser, an application of the PC 1 owned by the user, in order to receive information and a service. On the other hand, an information provider or a service provider is capable of providing information or a service to the WWW browser implemented by the PC 1 through the WWW server implemented by the IP server 5 or the SP server 3.

It should be noted that the PC 1 of the user can be connected to the Internet 4 directly. Normally, however, the user enters into a contract with an information/service provider to have the PC 1 thereof connected to the Internet 4 as part of the Internet 4 through accesses to the SP server 3 (or the IP server 5) made by way of the public network 2 as shown in FIG. 1.

In addition, SP servers other than the SP server 3 and IP servers other than IP server 5 which are not shown in the figure are also connected to the Internet 4.

In a network system with a configuration described above, the user establishes a communication link between the PC 1 and the SP server 3 through an access to the SP server 3 made by way of the public network 2 by operating the PC 1.

In addition, when the user enters the address (or the URL) of a home page that is stored (recorded) in the IP server 5 by operating the PC 1, the IP server 5 transmits the home page to the SP server 3 by way of the Internet 4. The home page received by the SP server 3 from the IP server 5 is then forwarded to the PC 1 by way of the public network 2. The home page specified by the address entered by the user is finally displayed on the PC 1.

When necessary, a home page stored/recorded in the IP server 5 may include the URL of information or a file of a link destination specified by using an <A> tag as described before. In addition, the home page may also include a line number (or a telephone number) assigned to the telephone line of equipment such as the computer 6, the FAX-information providing apparatus 7, the telephone set 8, the host computer 9 and the voice-mail handling apparatus 10 which are used as a destination link.

That is to say, in the present embodiment, a new tag type is added to the HTML so that a telephone number can be specified as a link destination, allowing a link to a string of characters and an image to be prescribed. The newly defined tag is a telephone-number tag (or a line-number tag) prescribed by a code such as <TEL>. In this way, equipment such as the computer 6, the FAX-information providing apparatus 7, the telephone set 8, the host computer 9 and the voice-mail handling apparatus 10 can be specified as a link destination in addition to home pages stored in a WWW server.

In addition, in order to establish communication with equipment such as the computer 6, the FAX-information providing apparatus 7, the telephone set 8, the host computer 9 and the voice-mail handling apparatus 10, it is necessary to adopt a communication procedure (a connection method or a communication method) for the respective piece of equipment. Thus, as a transfer protocol is included in a URL described in an <A> tag, for example, information representing a communication procedure (a connection method or a communication method) for establishing communication with each of the pieces of equipment such as the computer 6, the FAX-information providing apparatus 7, the telephone set 8, the host computer 9 and the voice-mail handling apparatus 10 can be appended to a telephone number prescribed along with a telephone-number tag. The communication procedure (a connection method or a communication method) may be referred to hereafter as the type of connection according to circumstances.

A combination of a telephone number of a link destination and the type of connection with the link destination (that is, the communication procedure, the connection method or the communication method) described above may be referred to hereafter as TELINFO (telephone information) according to circumstances.

After a home page described in an HTML including a newly defined telephone-number tag described above is displayed on the PC 1, the user can specify a predetermined display portion associated with the telephone-number tag by operating the PC 1. By doing so, the PC 1 calls a telephone number described along with the telephone-number tag and further establishes a communication link with a piece of equipment connected to a telephone line, to which the telephone number is assigned, through the public network 2 in accordance with a communication procedure corresponding to a type of connection added to the telephone number described along with the telephone-number tag.

As a result, by using the PC 1, the user is capable of exchanging information with the computer 6 which is capable of carrying out communication only in a protocol other than the http adopted as a transfer protocol for a home page. Examples of protocols other than the http are the ftp and the telnet protocol. In addition, by using the PC 1, the user is also capable of exchanging information with equipment such as the FAX-information providing apparatus 7, the telephone set 8, the host computer 9 and the voice-mail handling apparatus 10, apparatuses each carrying out communication according to a communication procedure other than the communication procedure that can be described as the name of a transfer protocol along with a URL in an <A> tag.

In addition, since the PC 1 is connected to each of the pieces of equipment such as the computer 6, the FAX-information providing apparatus 7, the telephone set 8, the host computer 9 and the voice-mail handling apparatus 10 through only the public network 2, by-passing the Internet 4, that is, since the PC 1 establishes communication with each of the pieces of equipment not through some servers, between which an unregulated segment may exist, on the so-called one-to-one basis, the protection of security can be made better than the ordinary system.

Furthermore, in the present embodiment, a telephone number assigned to a telephone line connecting the IP server 5 to the public network 2 can be prescribed along with a telephone-number tag on a home page. Thus, the PC 1 is also capable of establishing communication with the IP server 5 used as a WWW server only through the public network 2, by-passing the Internet 4.

As a result, when an online-shopping service is provided by an IP server 5 through a home page, for example, secret information such as the number of a credit card or the number of a bank account owned by the user can be transmitted from the PC 1 to the IP server 5 directly by way of only the public network 2, by-passing the Internet 4. In this case, it is thus possible to reduce the possibility that a third person illegally steals (or taps) the secret information.

In addition, information other than secret one can also be exchanged between the PC 1 and the IP server 5 only through the public network 2. In this case, the speed of communication between the PC 1 and the IP server 5 can be maintained at a predetermined value. This is because, in communication through the Internet 4, information is transmitted by way of a route through which a large amount of other information is exchanged as described earlier. If information is transmitted by way of only the public network 2, by-passing the Internet 4, on the other hand, there is basically no decrease in communication speed.

FIG. 2 is a diagram showing a typical configuration of the PC 1 shown in FIG. 1. A ROM (Read Only Memory) unit 11 shown in FIG. 2 is used for storing a system program. A CPU (Central Processing Unit) 12 carries out various kinds of processing by execution of the system program stored in the ROM unit 11 and a program, strictly speaking, an application program loaded on a RAM (Random-Access Memory) unit 13. The RAM unit 13 is used for storing a program and data required by the CPU 12 in carrying out the processing according to circumstances. An input/output unit 14 comprises input facilities such as a keyboard, a mouse and a microphone for inputting a variety of commands and other necessary information, and output facilities such as a display unit, a printer and a speaker for displaying and printing characters and images as well as outputting audio information respectively.

An interface (I/F) unit 15 controls operations to exchange data between the CPU 12 and an external storage apparatus 16, a data communication unit 17 and a public-network communication unit 18. Typically implemented by a hard-disk drive or a photo-magnetic-disk drive, the external storage apparatus 16 is used for storing necessary data and programs. Typically implemented by a modem, the data communication unit 17 carries out control required in communication with the SP server 3 through the public network 2. Typically implemented by an NCU (Network Control Unit) or a modem, the public-network communication network 18 carries out control required in communication with equipment such as the IP server 5, the computer 6, the FAX-information providing apparatus 7, the telephone set 8, the host computer 9 and the voice-mail handling apparatus 10 through the public network 2.

It should be noted that, in the present embodiment, the public-network communication unit 18 is capable of typically transmitting at least a DTMF (Dual Tone Multi Frequency) signal.

Next, the operation of the PC 1 is explained by referring to a flowchart shown in FIG. 3.

As shown in the figure, the flowchart begins with a step S1 at which the WWW browser is activated by the user when the user carries out an operation on the input/output unit 14 to activate the WWW browser. When the user carries out an operation on the input/output unit 14 to establish communication with the SP server 3, the flow of the operation goes on to a step S2 at which the CPU 12 controls the data communication unit 17 to establish a communication link with the SP server 3.

Later on, when the user carries out an operation on the input/output unit 14 to specify (make a request for) a home page, the flow of the operation proceeds to a step S3 at which the request for a home page is transmitted from the data communication unit 17 to the SP server 3 by way of the public network 2. To put it in detail, at the step S3, the URL of the requested home page entered by the user is transmitted from the data communication unit 17 employed in the PC 1 to the SP server 3 by way of the public network 2.

It should be noted that a URL can be entered directly to a predetermined area on a display screen of the WWW browser, or in the case of a home-page screen displayed on the input/output unit 14 of the PC 1 with a link destination sandwiched by an <A> tag and an </A> tag, the user clicks a predetermined portion on the screen by using a device such as mouse of the input/output unit 14 to confirm the requested home page. It should be noted that the predetermined portion of the screen is a portion associated with the URL of the requested home page.

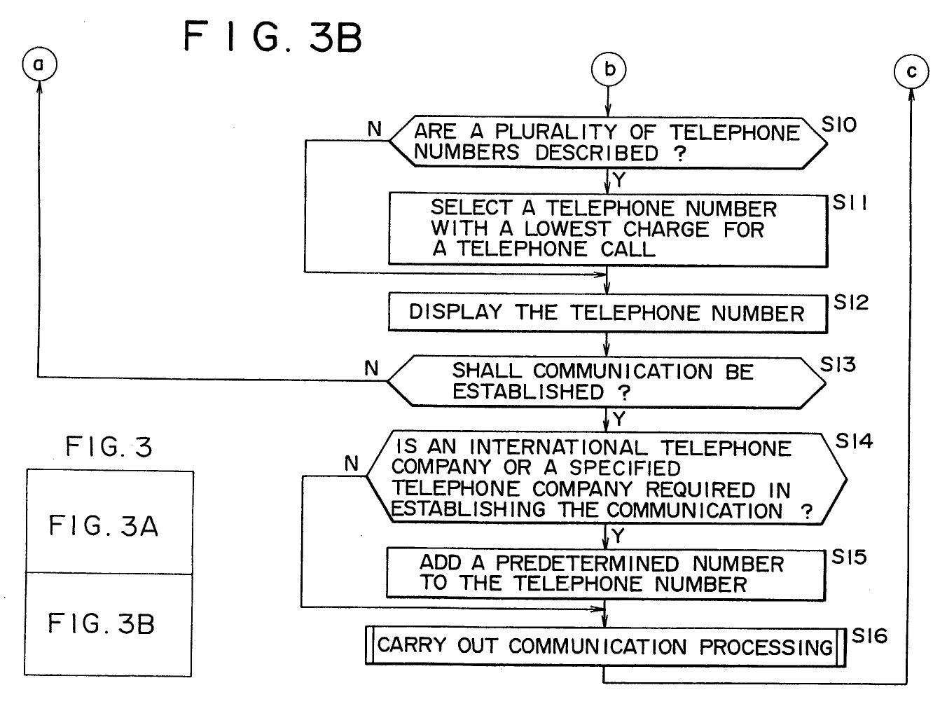

Here, in the present embodiment, the SP server 3 is designed to also function as a DNS. Receiving a URL from the PC 1, the SP server 3 acquires an IP (Internet Protocol) address from the URL. Assume, for example, that the IP address is the address of the IP server 5. In this case, the SP server 3 makes a request to the IP server 5 for a home page indicated by the URL. Receiving the request from the SP server 3, the IP server 5 which also serves as a WWW server transmits a home page indicated by the URL to the SP server 3 by way of the Internet 4. In turn, the SP server 3 passes on the home page to the PC 1 by way of the public network 2. At that time, the flow of the operation continues to a step S4 at which the data communication unit 17 employed in the PC 1 receives the home page transmitted by the SP server 3. The home page is then forwarded by the data communication unit 17 to the input/output unit 14 by way of the interface unit 15. At that time, the flow of the operation goes on to a step S5 at which the input/output unit 14 displays the home page received from the data communication unit 17. To put in detail, the home page is displayed typically on a WWW browser (or a window) 21 opened on a display screen of the input/output unit 14 as shown in FIG. 4.

With a home page displayed on a WWW browser 21 as shown in FIG. 4, when a cursor 23 is moved to a portion on the WWW browser 21 linked to another home page, that is, a portion associated with a URL described in an <A> tag, the URL of a linked home page is displayed on a URL display portion 22 located typically at the bottom of the WWW browser 21. When the cursor 23 is moved to a portion associated with TELINFO data in a telephone-number tag, the TELINFO data is displayed on a URL display portion 22.

It should be noted that a portion associated with a URL or TELINFO data is typically displayed in a specific color or displayed as a graphic of a button or an icon. When the cursor 23 is moved to such a portion, the shape of the cursor 23 is changed to graphic such as the tip of a finger that leads the user to press a button. With such a scheme, the user is capable of easily recognizing a portion associated with a URL or TELINFO data which may be referred to hereafter simply as a link display portion according to circumstances.

After the home page has been displayed, the flow of the operation goes on from a step S5 to a step S6 at which the CPU 12 forms a judgment as to whether or not the user has clicked the link display portion. If the outcome of the judgment formed at the step S6 indicates that the link display portion has not been clicked, the flow of the operation proceeds to a step S7 at which the CPU 12 forms a judgment as to whether or not the input/output unit 14 has been operated to end the processing. If the outcome of the judgment formed at the step S7 indicates that the inp ut/output unit 14 has been operated to end the processing, the flow of the operation proceeds to a step S8 at which the CPU 12 requests the data communication unit 17 to cut off the line connected to the SP server 3 in order to end the processing. If the outcome of the judgment formed at the step S7 indicates that the input/output unit 14 has not been operated to end the processing, on the other hand, the flow of the operation returns to the step S5.

If the user clicks the link display portion by operating the input/output unit 14, the outcome of the judgment formed at the step S6 will indicate that the link display portion has been clicked. In this case, the flow of the operation proceeds to a step S9 at which the CPU 12 forms a judgment as to whether or not a telephone-number tag is described in the link display portion. If the outcome of the judgment formed at the step S9 indicates that no telephone-number tags are described in the link display portion, that is, if an <A> tag is described in the link display portion, the flow of the operation returns to the step S3 to make a request for a home page indicated by a URL specified in the <A> tag.

To put it in detail, the URL specified in the link display portion clicked by the user is transmitted from the data communication unit 17 employed in the PC 1 to the SP server 3. Thereafter, a WWW server storing a home page indicated by the URL transmits the home page to the PC 1 in the same way as what has been described earlier. The flow of the operation then goes on to the step S4 to receive the home page before proceeding to the step S5 to display it.

If the outcome of the judgment formed at the step S9 indicates that a telephone-number tags is described in the link display portion, on the other hand, the flow of the operation goes on to a step S10 at which the CPU 12 read out TELINFO data described along with the telephone-number tag and forms a judgment as to whether or not a plurality of telephone numbers are included in the TELINFO data.

It should be noted that TELINFO data may include more than one telephone number. In the case of the so-called mirror sites, for example, a plurality of FAX-information providing apparatuses 7 having the same FAX information may be installed at a variety of locations all over the country or even installed in different countries all over the world. In such a case, the TELINFO data of the FAX-information providing apparatus 7 may include a plurality of telephone numbers assigned to FAX-information providing apparatuses 7 installed at a variety of locations all over the country or even installed at various locations in different countries all over the world.

If the outcome of the judgment formed at the step S10 indicates that a plurality of telephone numbers are included in the TELINFO data, the flow of the operation goes on to a step S11 at which the CPU 12 selects one of the telephone numbers most convenient to the user, for example, a telephone number of a FAX-information providing apparatus installed at a location closest to the PC 1 or a telephone number costing a lowest charge for a telephone call. The flow of the operation then goes on to a step S12.

If the outcome of the judgment formed at the step S10 indicates that a plurality of telephone numbers are not included in the TELINFO data, that is, if only one telephone number is included in the TELINFO data, on the other hand, the flow of the operation goes on to the step S12, skipping the step S11. At the step S12, the telephone number selected at the step S11 or the only telephone number included in the TELINFO data is displayed on the input/output unit 14.

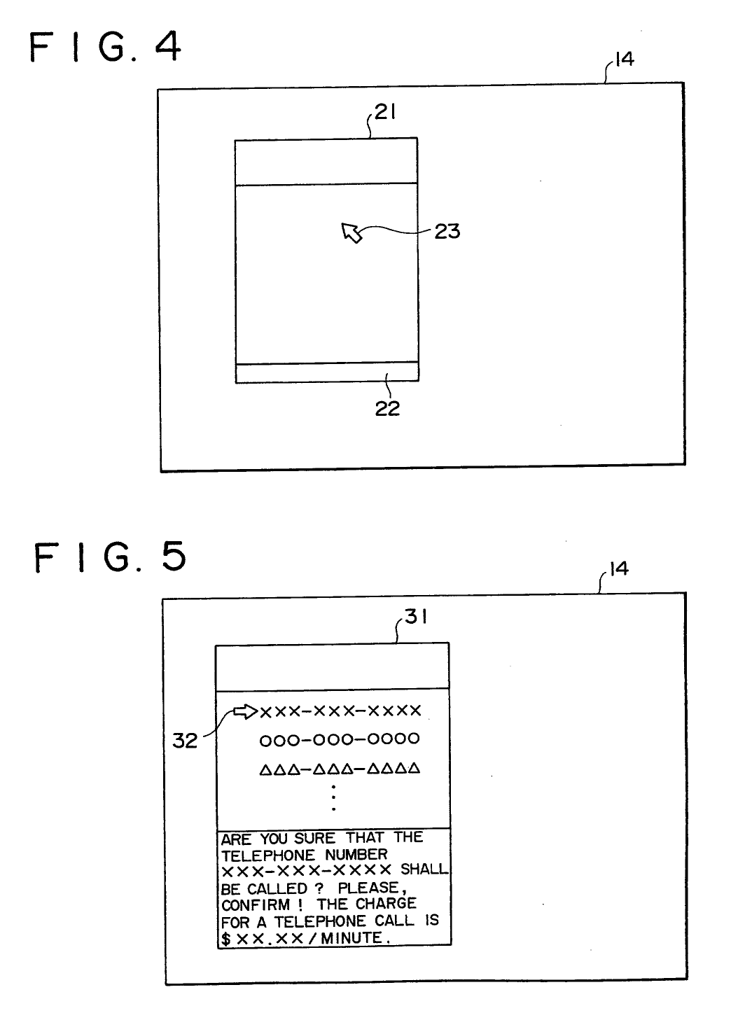

In the input/output unit 14, a window 31 is typically opened as shown in FIG. 5. On the window 31, a message is displayed, requesting the user to confirm that a displayed telephone number (XX-XXX-XXXX) can indeed be called. The message typically says: “Are you sure that the telephone number XX-XXX-XXXX shall be called? Please, confirm!” In addition to the message inquiring the user's confirmation, a charge for a telephone call, typically a telephone fee per minute ($xx.xx/minute), is also displayed as well. It should be noted that the charge for a telephone call is computed by the CPU 12 from the telephone number.

It is worth noting that, if a plurality of telephone numbers are included in the TELINFO data, a list of all the telephone numbers is displayed on the inpu t/output unit 14. In this case, a predetermined mark 32 is appended to the telephone number selected at the step S11 as shown in FIG. 5. In this way, the user is capable of recognizing a telephone number costing a lowest charge for a telephone call with ease. In addition, the mark 32 can be moved to the position of another telephone number on the list by operating the input/output unit 14. If a plurality of telephone numbers are included in the TELINFO data, in communication processing carried out at a step S16 to be described later, a call is make to a telephone number with the mark 32 appended thereto.

Looking at the display like the one described above, the user makes a decision as to whether or not a call shall be made to a telephone number with the mark 32 appended thereto, operating the input/output unit 14 in accordance with the decision. The flow of the operation then goes on to a step S13 to form a judgment as to whether or not the input/output operation 14 has been operated to make a call to the telephone number. If the outcome of the judgment formed at the step S13 indicates that the in put/output operation 14 has been operated to make no call to the telephone number, the flow of the operation returns to the step S5 at which the original home page is displayed again.

If the outcome of the judgment formed at the step S13 indicates that the input/output operation 14 has been operated to make a call to the telephone number, on the other hand, the flow of the operation goes on to the step S14 at which the CPU 12 forms a judgment as to whether or not it is necessary to use an international telephone company or a long-distance telephone company in order to make a call to the telephone number included in the TELINFO data or, if a plurality of telephone numbers are included in the TELINFO data, a telephone number with the mark 32 appended thereto. If the outcome of the judgment formed at the step S14 indicates that it is necessary to use an international telephone company or a long-distance telephone company, the flow of the operation proceeds to a step S15 at which a predetermined number required by the international telephone company or the long-distance telephone company is added to the telephone number by the CPU 12. The flow of the operation then goes on to a step S16.

If the outcome of the judgment formed at the step S14 indicates that it is not necessary to use an international telephone company or a long-distance telephone company, on the other hand, the flow of the operation proceeds directly to the step S16, skipping the step S15. At the step S16, communication processing according to a communication procedure corresponding to a type of connection described in the TELINFO data is carried out. The flow of the operation then returns to the step S2.

In the communication processing carried out at the step S16, the public-network communication unit 18 calls the telephone number by using a DTMF signal to establish a communication link according to a communication procedure for the type of connection included in the TELINFO data.

In the case of a PSTN telephone line connected to the PC 1, as a general rule, a telephone number is called with a communication link to the SP server 3 established and, in order to carry out communication with an apparatus to which the telephone number is assigned, two physical telephone lines are thus required. It is not desirable, however, to provide two physical telephone lines as such. In order to solve this problem, the telephone line connecting the PC 1 to the SP server 3 (Internet 4) is temporarily cut off and the telephone number is then called to carry out communication with the apparatus to which the telephone number is assigned. After the communication is completed, the PC 1 again establishes a communication link with the SP server 3. In this way, communication can be carried out by using only one telephone line.

It should be noted that, if the line of the called telephone number is in the so-called busy state, for example, the attempt made to establish a communication link with the apparatus to which the telephone number is assigned ends in a failure. In case a previous attempt made to establish such a communication link has ended in a failure, either repeated processing is carried out to try again to establish a communication link with the target apparatus by re-calling the telephone number, or the cut-off communication line with the SP server 3 may be just re-established. In case an attempt made to establish such a communication link with a target apparatus ends in a failure, the user is allowed to make a decision as to whether the telephone number should be re-called or the cut-off communication line with the SP server 3 should be re-established by operating the input/output unit 14.

In the case of an ISDN telephone line connected to the PC 1, on the other hand, since one physical telephone line capable of serving as a plurality of logical telephone lines, communication with a target apparatus to which the called telephone number is assigned can be established at the same time as communication with the SP server 3 even if only one physical telephone line is provided. That is to say, it is not necessary to cut off the line connected to the SP server 3 temporarily in order to make a call to the telephone number.

The following is description of an embodiment wherein the PC 1 is connected to one physical PSTN telephone line.

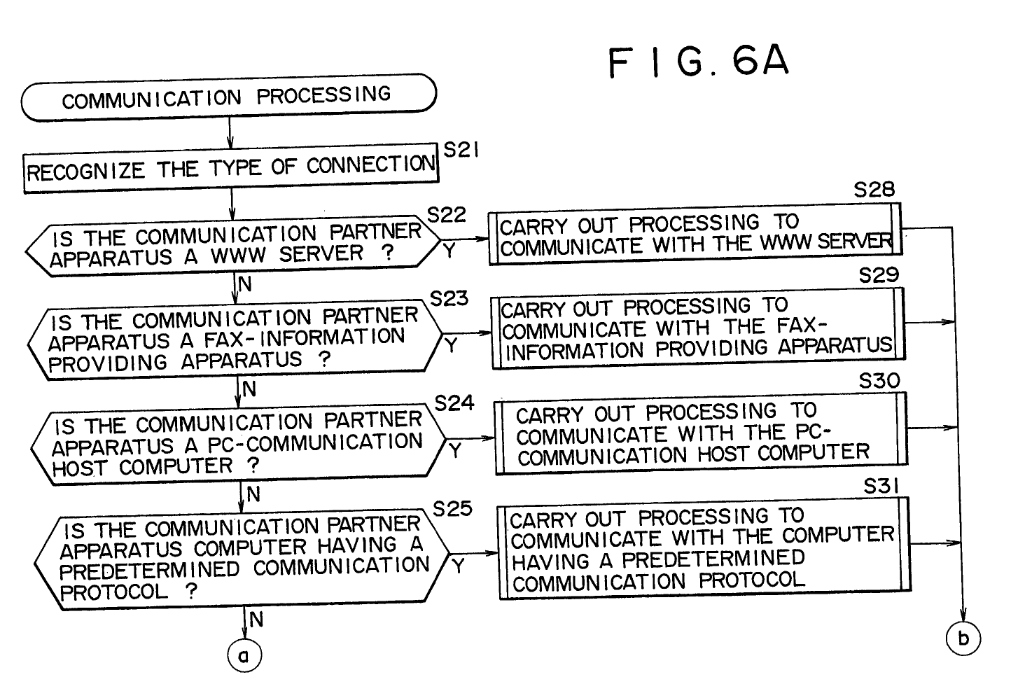

FIG. 6 shows a flowchart representing details of the communication processing carried out at the step S16 of the flowchart shown in FIG. 3.

As shown in FIG. 6, the flowchart of the communication processing begins with a step S21 at which the CPU 12 recognizes the type of connection included in the TELINFO data. At each of the subsequent steps S22 to S27, the type of connection is then used for forming a judgment as to whether the apparatus serving as a communication partner is a WWW server, a FAX-information apparatus, a host computer of PC communication, a computer capable of carrying out communication based only on a predetermined communication protocol, a voice-mail handling apparatus or a telephone set respectively. If the outcome of the judgment formed at any one of the subsequent steps S22 to S27 indicates that the apparatus serving as a communication partner is a WWW server, a FAX-information apparatus, a host computer of PC communication, a computer capable of carrying out communication based only on a predetermined communication protocol, a voice-mail handling apparatus or a telephone set, the flow of processing goes on to one of steps S28 to S33 respectively at which processing required for carrying out communication with the respective apparatus serving as a communication partner is executed before returning to the flowchart shown in FIG. 3.

If none of the outcome of the judgment formed at any one of the subsequent steps S22 to S27 indicates that the apparatus serving as a communication partner is a WWW server, a FAX-information apparatus, a host computer of PC communication, a computer capable of carrying out communication based only on a predetermined communication protocol, a voice-mail handling apparatus or a telephone set, that is, if the outcome of the judgment formed at the last step S27 indicates that the apparatus serving as a communication partner is not a telephone set, on the other hand, the flow returns to the flowchart shown in FIG. 3 without doing any processing.

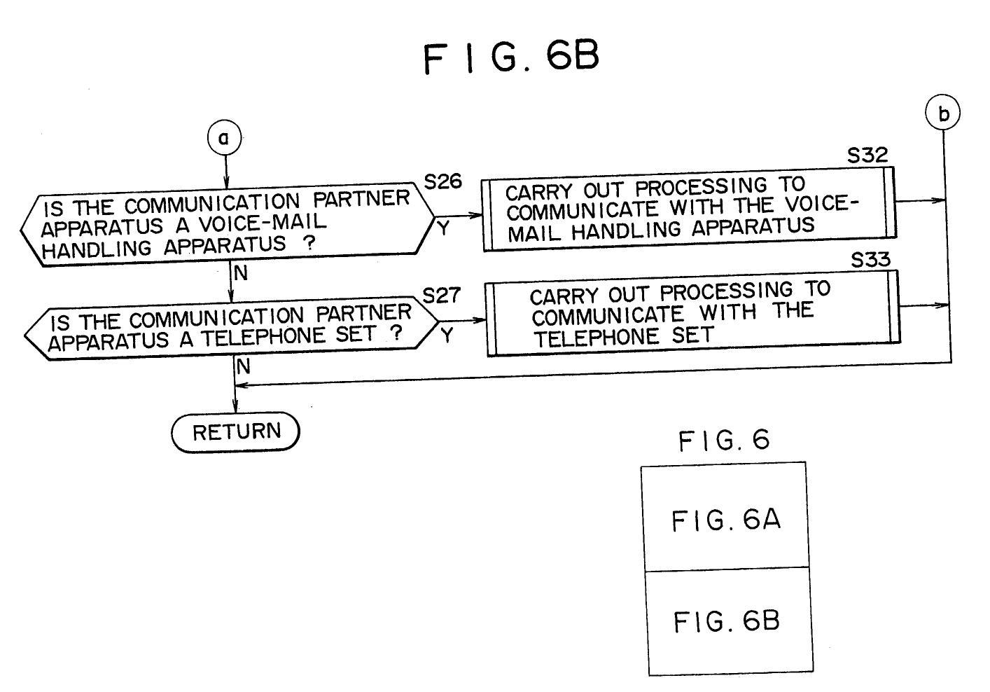

FIG. 7 shows a flowchart representing details of the processing which is carried out at the step S28 of the flowchart shown in FIG. 6 when the outcome of the judgment formed at the step S22 indicates that the apparatus serving as a communication partner is a WWW server.

As shown in FIG. 7, the flowchart begins with a step S41 at which a communication link with the WWW server is established. In this case, since the TELINFO data typically includes a telephone number assigned to the IP server 5 connected to the public line 2, first of all, the CPU 12 controls the data communication line 17 to cut off the line connected to the SP server 3. The CPU 12 then controls the public-network communication unit 18 to call the telephone number of the IP server 5, establishing a communication line with the IP server 5 through only the public network 2. It should be noted that the communication link with the IP server 5 is established in accordance with a communication procedure corresponding to a type of connection included in the TELINFO data.

The flow of processing then goes on to a step S42 to make a request for a home page in the same way as the processing carried out at the step S3. Then, the flow of processing proceeds to a step S43 at which the home page transmitted by the IP server 5 by way of only the public network 2 in response to the request is received by the public-network communication unit 18 employed in the PC 1 and displayed on the input/output unit 14.

Subsequently, the flow of processing continues to a step S44 at which the PC 1 carries out predetermined processing as follows.

Assume that the home page received and displayed at the step S43 is a home page for an online shopping. In this case, the home page introduces a variety of commodities in a simple and plain manner. Normally, details of each of the commodities are described in another home page which may be referred to hereafter as a commodity introducing home page according to circumstances. If the URL of a commodity introducing home page is specified on the online-shopping home page, the user can click the simple and plain explanation of a desired commodity on the online-shopping home page by operating the input/output unit 14. In this case, the public-network communication unit 18 employed in the PC 1 transmits the URL of the commodity introducing home page for the clicked portion to the IP server 5 by way of only the public network 2. Receiving the URL, the IP server 5 transmits data of the home page, strictly speaking, the commodity introducing home page indicated by the URL, to the PC 1 by way of only the public network 2. The PC 1 then receives and displays the commodity introducing home page.

Assume that, after looking at the commodity introducing home page, the user makes a decision to place an order for the commodity described on the commodity introducing home page. In this case, the user enters an identification number for identifying the commodity, the number of a credit card for payment of the commodity and other information, which may be all referred to hereafter as necessary information according to circumstances, by operating the input/output unit 14. As the user further operates the input/output unit 14 to transmit the necessary information, the public-network communication unit 18 transmits the necessary information to the IP server 5 by way of only the public network 2.

Receiving the necessary information from the PC 1, the IP server 5 in turn places an order for the commodity to a store. On a later day, the store delivers the ordered commodity to the user accordingly. In addition, money is drawn by the store by using the number of the credit card specified in the necessary information.

The flow of processing then goes on to a step S44 at which the PC 1 drives the input/output unit 14 to complete the home shopping. Then, the flow of processing proceeds to a step S45 at which at which the CPU 12 controls the public-network communication unit 18 to cut off the line connected to the IP server 5 and then controls the data communication unit 17 to restore the connection link to the SP server 3 before returning to the flowchart shown in FIG. 6.

It should be noted that an online-shopping service like the one explained above can be rendered only to a user concluding a contract. Before the user can place an order for a commodity through the commodity introducing home page received and displayed at the step S43, a message is displayed to request the user to enter an ID and a password issued to the user concluding a contract. In response to the message, the user can enter the ID and the password at the step S44.

A procedure for concluding a contract can be executed by the user by sending a predetermined application form or by carrying out a so-called online sign-up.

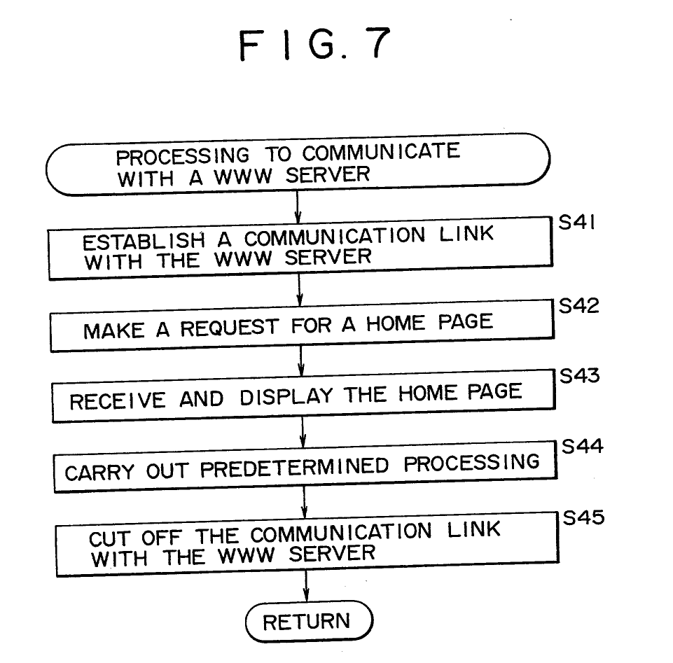

FIG. 8 shows a flowchart representing details of the processing which is carried out at the step S29 of the flowchart shown in FIG. 6 when the outcome of the judgment formed at the step S23 indicates that the apparatus serving as a communication partner is a FAX-information providing apparatus.

As shown in FIG. 8, the flowchart begins with a step S51 at which a communication link with the FAX-information providing apparatus 7 is established. In this case, since the TELINFO data typically includes a telephone number assigned to the FAX-information providing apparatus 7 connected to the public line 2, first of all, the CPU 12 controls the data communication line 17 to cut off the line connected to the SP server 3. The CPU 12 then controls the public-network communication unit 18 to call the telephone number of the FAX-information providing apparatus 7, establishing a communication line with the FAX-information providing apparatus 7 through only the public network 2. It should be noted that the communication link with the FAX-information providing apparatus 7 is established in accordance with a communication procedure corresponding to a type of connection included in the TELINFO data.

As the communication link with the FAX-information providing apparatus 7 is established, the FAX-information providing apparatus 7 transmits a description of the usage thereof or an instruction requesting the user to operate push buttons in order to specify desired FAX information as a voice message, which may be referred to hereafter as a guidance message according to circumstances, to the PC 1. The voice guidance message is received by the public-network communication unit 18 employed in the PC 1 and output through the input/output unit 14 at the following step S52. The user listens to the guidance message and then operates the input/output unit 14 so as to obtain the desired FAX information.

As the input/output unit 14 is operated by the user, the flow of processing goes on to a step S53 at which the public-network communication unit 18 transmits a DTMF signal representing the operation carried out by the user on the input/output unit 14 to the FAX-information providing apparatus 7 by way of the public network 2. Receiving the DTMF signal from the PC 1, the FAX-information providing apparatus 7 transmits FAX information indicated by the DTMF signal to the PC 1 by way of the public network 2. At the following step S54, the FAX information or the FAX data is received by the public-network communication unit 18 employed in the PC 1 and then printed by the input/output unit 14 on pieces of paper. As an alternative, the FAX data is just displayed on the in put/output unit 14.

After transmitting the FAX information, the FAX-information providing apparatus 7 transmits a message informing the user of completion of the service as a voice message, which may be referred to hereafter as an end message according to circumstances, to the PC 1. The voice end message is received by the public-network communication unit 18 employed in the PC 1 and output to the input/output unit 14 at the following step S55.

The user listens to the end message and as the user operates the input/output unit 14 so as to end the processing, the flow goes on to a step S56 at which the CPU 12 controls the public-network communication unit 18 to cut off the line connected to the FAX-information providing apparatus 7 and then controls the data communication unit 17 to restore the connection link to the SP server 3 before returning to the flowchart shown in FIG. 6.

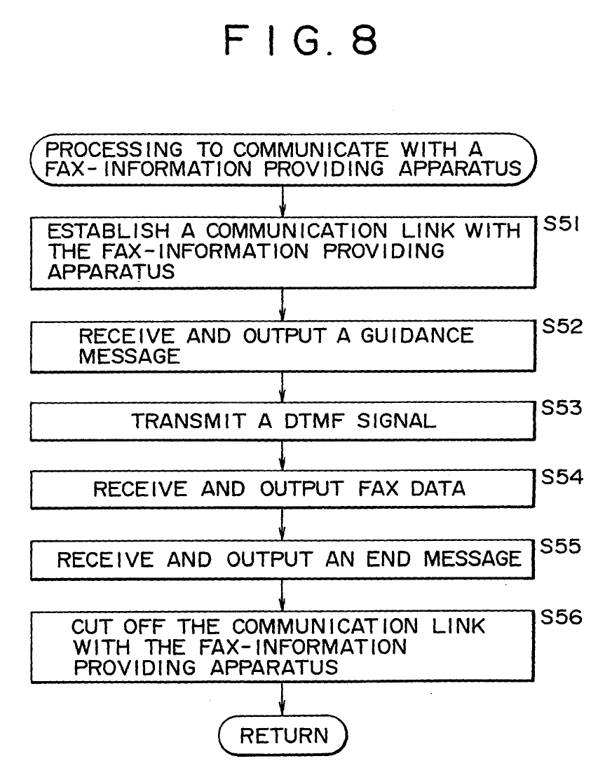

FIG. 9 shows a flowchart representing details of the processing which is carried out at the step S30 of the flowchart shown in FIG. 6 when the outcome of the judgment formed at the step S24 indicates that the apparatus serving as a communication partner is a host computer of PC communication.

As shown in FIG. 9, the flowchart begins with a step S61 at which a communication link with the host computer 9 of the PC communication is established. In this case, since the TELINFO data typically includes a telephone number assigned to the host computer 9 of the PC communication connected to the public line 2, first of all, the CPU 12 controls the data communication line 17 to cut off the line connected to the SP server 3. The CPU 12 then controls the public-network communication unit 18 to call the telephone number of the host computer 9 of the PC communication, establishing a communication line with the host computer 9 through only the public network 2. It should be noted that the communication link with the host computer 9 of the PC communication is established in accordance with a communication procedure corresponding to a type of connection included in the TELINFO data.

As the communication link with the host computer 9 of the PC communication is established, the host computer 9 transmits a message requesting the user to enter an ID and a password to the PC 1. In response to the message, the user enters an ID and a password by operating the inp ut/output unit 14.

Much like the online-shopping service, in general, a PC-communication service can be rendered only to a user concluding a contract. Before the user can receive a PC-communication service, a message is therefore displayed to request the user to enter an ID and a password issued to the user concluding a contract. It is thus necessary for the user to conclude a contract with a service providing company rendering PC-communication services through the host computer 9 in advance. A procedure for concluding a contract can be executed by the user by, for example, sending a predetermined application form or by carrying out the so-called online sign-up.

As the user enters an ID and a password by operating the input/output unit 14, the flow of processing goes on to a step S62 at which the public-network communication unit 18 transmits the ID and the password to the host computer 9 by way of the public network 2. The host computer 9 then authenticates the ID and the password transmitted from the PC 1 by forming a judgment as to whether or not the combination of the ID and the password matches that of the user concluding a contract. If the outcome of the judgment indicates that the combination of the ID and the password matches that of the user concluding a contract, a PC-communication service is started.

Then, as the user operates the input/output unit 14 in an attempt to get the PC-communication service, the flow of processing proceeds to a step S63 at which the CPU 12 carries out various kinds of processing in accordance with the operation carried out by the user on the input/output unit 14. For example, the user is allowed to send another user an electronic mail by utilizing the PC-communication service rendered by the host computer 9 and to look at an electronic mail received from another user. Other PC-communication services rendered by the host computer 9 to the user include chat, electronic announcements and electronic conferences.

As the user operates the input/output unit 14 so as to end the processing, the flow goes on to a step S64 at which the CPU 12 controls the public-network communication unit 18 to cut off the line connected to the host computer 9 and then controls the data communication unit 17 to restore the connection link to the SP server 3 before returning to the flowchart shown in FIG. 6.

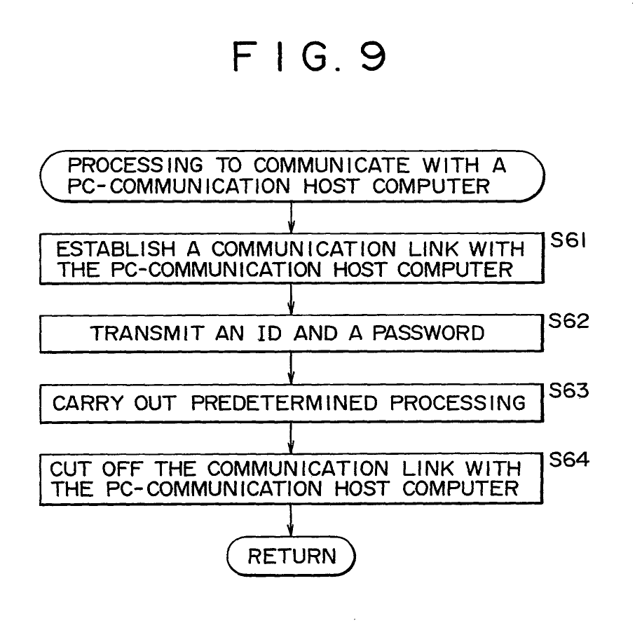

FIG. 10 shows a flowchart representing details of the processing which is carried out at the step S31 of the flowchart shown in FIG. 6 when the outcome of the judgment formed at the step S25 indicates that the apparatus serving as a communication partner is a computer capable of carrying out communication in accordance with only a predetermined communication protocol. Such a computer may be referred to hereafter simply as a predetermined-protocol computer according to circumstances.

As shown in FIG. 10, the flowchart begins with a step S71 at which a communication link with the predetermined-protocol computer 6 is established. In this case, since the TELINFO data typically includes a telephone number assigned to the predetermined-protocol computer 6 connected to the public line 2, first of all, the CPU 12 controls the data communication line 17 to cut off the line connected to the SP server 3. The CPU 12 then controls the public-network communication unit 18 to call the telephone number of the predetermined-protocol computer 6, establishing a communication line with the predetermined-protocol computer 6 through only the public network 2. It should be noted that the communication link with the predetermined-protocol computer 6 is established in accordance with a communication procedure corresponding to a type of connection included in the TELINFO data.

As the communication link with the predetermined-protocol computer 6 is established, the predetermined-protocol computer 6 transmits a message requesting the user to enter an ID and a password to the PC 1. In response to the message, the user enters an ID and a password by operating the input/output unit 14.

Much like the online-shopping service and the PC-communication service, in general, a service of the predetermined-protocol computer 6 can be rendered only to a user concluding a contract. Before the user can receive such a service, a message is therefore displayed to request the user to enter an ID and a password issued to the user concluding a contract. As the user enters an ID and a password by operating the input/output unit 14, the flow of processing goes on to a step S72 at which the public-network communication unit 18 transmits the ID and the password to the predetermined-protocol computer 6 by way of the public network 2. The predetermined-protocol computer 6 then authenticates the ID and the password transmitted from the PC 1 by forming a judgment as to whether or not the combination of the ID and the password matches that of the user concluding a contract. If the outcome of the judgment indicates that the combination of the ID and the password matches that of the user concluding a contract, the user is allowed to make a log-in through the PC 1.

Then, as the user carries out a predetermined operation on the input/output unit 14, the flow of processing proceeds to a step S73 at which the PC 1 carries out communication processing conforming to the predetermined communication protocol that can be used by the computer 6 in accordance with the operation carried out by the user. To put it in detail, the predetermined communication protocol can be recognized from the type of connection included in the TELINFO data. The CPU 12 controls the public-network communication unit 18 so as to carry out communication with the predetermined-protocol computer 6 in accordance with a communication procedure corresponding to the type of connection. As a result, the PC 1 is capable of carrying out communication with the predetermined-protocol computer 6 according to the predetermined protocol such as the ftp or the telnet protocol, the only protocol according to which the computer 6 is capable of carrying out communication.

As the user operates the input/output unit 14 so as to end the processing, the flow goes on to a step S74 at which the CPU 12 controls the public-network communication unit 18 to cut off the line connected to the predetermined-protocol computer 6 and then controls the data communication unit 17 to restore the communication link with the SP server 3 before returning to the flowchart shown in FIG. 6.

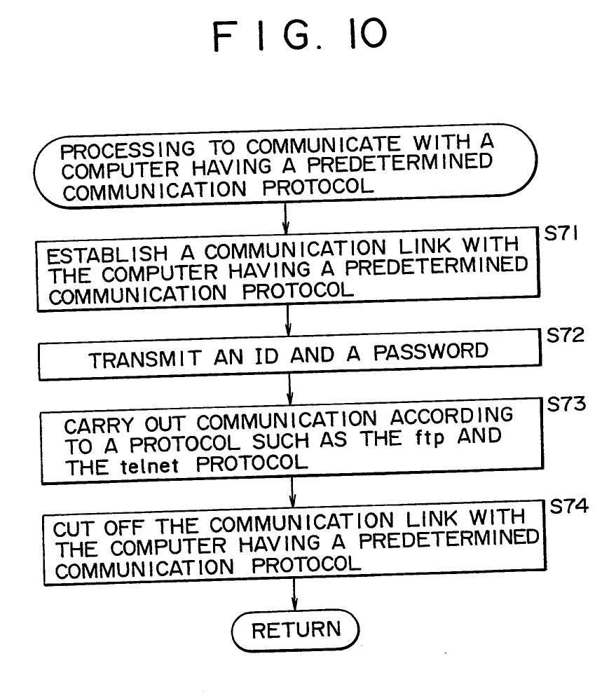

FIG. 11 shows a flowchart representing details of the processing which is carried out at the step S32 of the flowchart shown in FIG. 6 when the outcome of the judgment formed at the step S26 indicates that the apparatus serving as a communication partner is a voice-mail handling apparatus.

As shown in FIG. 11, the flowchart begins with a step S81 at which a communication link with the voice-mail handling apparatus 10 is established. In this case, since the TELINFO data typically includes a telephone number assigned to the voice-mail handling apparatus 10 connected to the public line 2, first of all, the CPU 12 controls the data communication line 17 to cut off the line connected to the SP server 3. The CPU 12 then controls the public-network communication unit 18 to call the telephone number of the voice-mail handling apparatus 10, establishing a communication line with the voice-mail handling apparatus 10 through only the public network 2. It should be noted that the communication link with the voice-mail handling apparatus 10 is established in accordance with a communication procedure corresponding to a type of connection included in the TELINFO data.

As the communication link with the voice-mail handling apparatus 10 is established, the voice-mail handling apparatus 10 transmits a description of the usage thereof or an instruction requesting the user to operate push buttons in order to specify a desired voice mail as a voice message, which may be referred to hereafter as a guidance message according to circumstances, to the PC 1. The voice guidance message is received by the public-network communication unit 18 employed in the PC 1 and output to the input/output unit 14 at the following step S82. The user listens to the guidance message and then operates the input/output unit 14 so as to obtain the desired voice mail.

As the input/output unit 14 is operated by the user, the flow of processing goes on to a step S83 at which the public-network communication unit 18 transmits a DTMF signal representing the operation carried out by the user on the input/output unit 14 to the voice-mail handling apparatus 10 by way of the public network 2. Receiving the DTMF signal from the PC 1, the voice-mail handling apparatus 10 plays back a voice mail indicated by the DTMF signal, transmitting the reproduced voice mail to the PC 1 by way of the public network 2. At the following step S84, the voice mail is received by the public-network communication unit 18 employed in the PC 1 and then output through the input/output unit 14 as voice.

After transmitting the voice mail, the voice-mail handling apparatus 10 transmits a message informing the user of completion of the service as a voice message, which may be referred to hereafter as an end message according to circumstances, to the PC 1 by way of the public network 2. The voice end message is received by the public-network communication unit 18 employed in the PC 1 and output through the input/output unit 14 at the following step S85.

The user listens to the end message and as the user operates the input/output unit 14 so as to end the processing, the flow goes on to a step S86 at which the CPU 12 controls the public-network communication unit 18 to cut off the line connected to the voice-mail handling apparatus 10 and then controls the data communication unit 17 to restore the communication link with the SP server 3 before returning to the flowchart shown in FIG. 6.

In the example described above, a voice mail is played back by the voice-mail handling apparatus 10. It should be noted that, by transmitting a predetermined DTMF signal to the voice-mail handling apparatus 10, voice generated by the user can also be recorded in the voice-mail handling apparatus 10 as an outgoing voice mail.

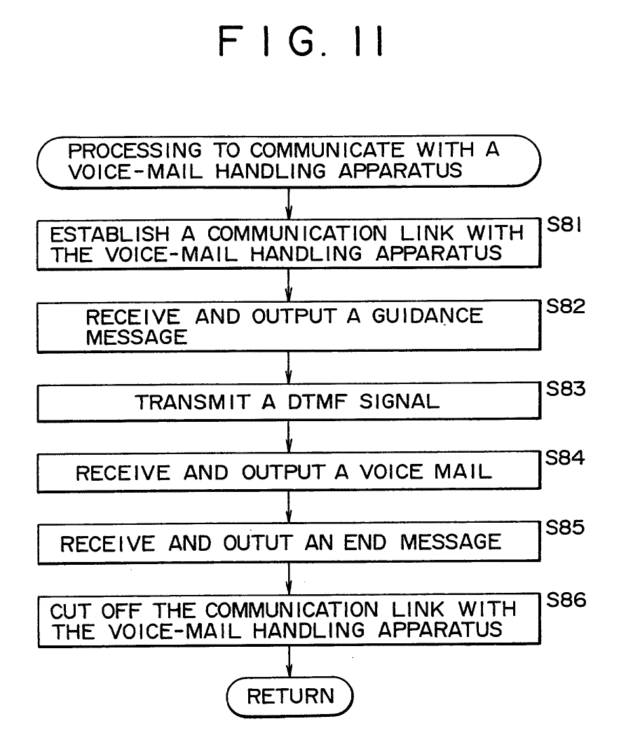

FIG. 12 shows a flowchart representing details of the processing which is carried out at the step S33 of the flowchart shown in FIG. 6 when the outcome of the judgment formed at the step S27 indicates that the apparatus serving as a communication partner is a telephone set.

As shown in FIG. 11, the flowchart begins with a step S91 at which a communication link with the telephone set 8 is established. In this case, since the TELINFO data typically includes a telephone number assigned to the telephone set 8 connected to the public line 2, first of all, the CPU 12 controls the data communication line 17 to cut off the line connected to the SP server 3. The CPU 12 then controls the public-network communication unit 18 to call the telephone number of the telephone set 8, establishing a communication line with the telephone set 8 through only the public network 2. It should be noted that the communication link with the telephone set 8 is established in accordance with a communication procedure corresponding to a type of connection included in the TELINFO data.

As the communication link with the telephone set 8 is established, the flow of processing goes on to a step S92 at which an audio signal can be exchanged between the PC 1 and the telephone set 8. To put it in detail, voice transmitted by the telephone set 8 is received by the public-network communication unit 18 employed in the PC 1 and output by the input/output unit 14. Conversely, voice entered by the user via the input/output unit 14 is transmitted by the public-network communication unit 18 to the telephone set 8 by way of the public network 2.

It should be noted that, in the case of a telephone set 8 having the so-called automatic answering function for automatically answering an incoming phone call in the absence of the telephone user, after the communication link between the PC 1 and the telephone set 8 has been established, the telephone set 8 transmits a voice message to the PC 1 in the absence of the telephone user. Typically, the voice message requests the caller to leave a message. In response to this voice message, the user of the PC 1 enters voice via the input/output unit 14. The voice is then transmitted by the public-network communication unit 18 to the telephone set 8 by way of the public network 2 to be recorded in the telephone set 8.

Later on, as the user operates the input/output unit 14 so as to end the processing, the flow goes on to a step S93 at which the CPU 12 controls the public-network communication unit 18 to cut off the line connected to the telephone set 8 and then controls the data communication unit 17 to restore the communication link with the SP server 3 before returning to the flowchart shown in FIG. 6.

FIG. 13 is a diagram showing a typical configuration of the IP server 5 shown in FIG. 1.

As shown in FIG. 13, the IP server 5 comprises elements from a ROM unit 61 to a public-network communication unit 68 constituting basically the same configuration as the PC 1 which has counterpart elements from the ROM unit 11 to the public-network communication unit 18. However, the elements employed in the IP server 5 have a capacity and/or speeds larger and/or higher than the corresponding elements employed in the PC 1.

An external storage/recording apparatus 66 is used for storing home pages each described in an HTML with an extended tag, that is, an HTML with a newly defined telephone-number tag. The home pages stored in the external storage/recording apparatus 66 are each associated with a URL. Implemented typically by a modem, a data communication unit 67 controls communication through the Internet 4. Typically implemented by an NCU (Network Control Unit) or a modem, the public-network communication network 68 carries out control required in communication with the public-network communication unit 18 employed in the PC 1.

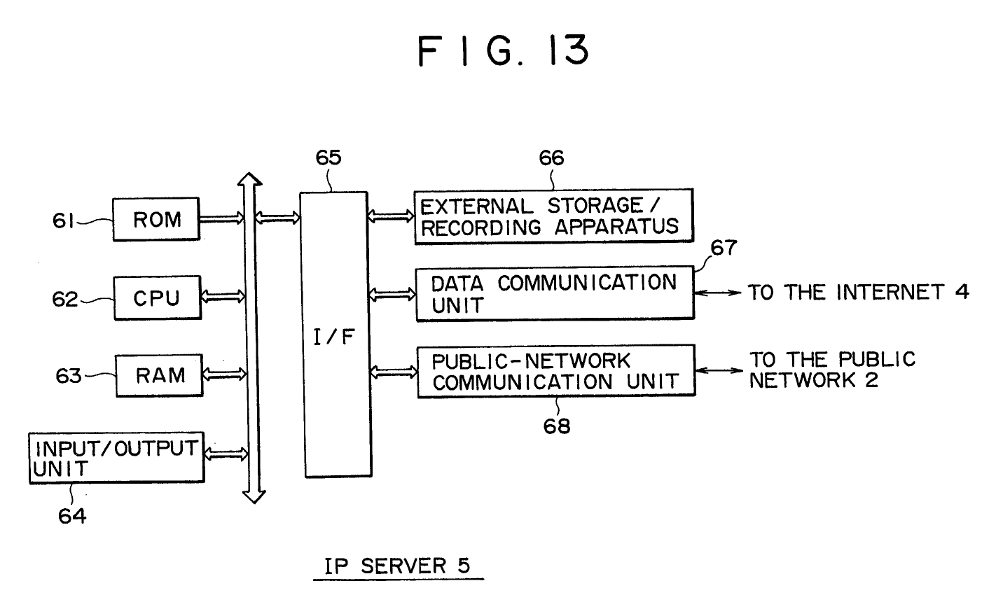

Next, the operation of the IP server 5 is explained by referring to a flowchart shown in FIG. 14.

As shown in the figure, the flowchart begins with a step S101 at which a CPU 62 employed in the IP server 5 forms a judgment as to whether or not a request for a home page has been received from the PC 1. If the outcome of the judgment formed at the step S101 indicates that no request for a home page has been received from the PC 1, the flow of the operation returns to the step S101. If the outcome of the judgment formed at the step S101 indicates that a request for a home page has been received from the PC 1, that is, if a URL entered by the user has been transmitted by the PC 1 to the IP server 5 by way of the SP server 3 and the Internet 4, on the other hand, the flow of the operation goes on to the step S102 at which the CPU 62 searches the external storage/recording apparatus 66 for a home page indicated by the URL, retrieves the home page from the external storage/recording apparatus 66 and transmits it to the data communication unit 17 employed in the PC 1 by way of the Internet 4 and the SP server 3. The PC 1 then receives and displays the home page indicated by the URL entered by the user as described above.

Later on, the flow of the operation returns to the step S101 to repeat the same processing.

It should be noted that, if an access to the IP server 5 is made by the PC 1 through only the public network 2 without going through the Internet 4, it is the public-network communication unit 68 employed in the IP server 5 that controls the communication.

It is worth noting that, while the present invention has been described above as an application to a network system utilizing the Internet 4, the scope of applications of the present invention is not limited to the a network system using the Internet 4. That is to say, the present invention can also be applied to a network system using a network other than the Internet such as the Intranet.

As described above, in the present embodiment, a telephone number is called by using a DTMF signal (a push-button signal). It should be noted, however, that a telephone number can also be called by using another signal such as a dial-pulse signal.

In addition, in order to make the explanation easy to understand, the PC 1 in the present embodiment is provided with the data communication unit 17 for controlling communication through also the Internet 4 and the public-network communication unit 18 for controlling communication through only the public network 2. In actuality, however, the data communication unit 17 and the public-network communication unit 18 can be physically implemented by one modem. By the same token, the data communication unit 67 and the public-network communication unit 68 employed in the IP server 5 can also be implemented by one modem as well.

Also in the present embodiment, the SP server 3 and the IP server 5 are provided separately from each other as described above. However, the present invention can also be applied to an information processing system wherein the functions of the SP server 3 and the IP server 5 are implemented by a single physical unit. It should be noted that, in this case, no server basically exists on a transmission line for exchanging information between the PC 1 and the SP server 3. Thus, even if information is exchanged between the data communication units 17 and 67, the protection of security can be assured and the speed of transmission can be maintained as is the case with data exchanges between the public-network communication units 18 and 68. If the PC 1 makes an access to the SP server 3 through a predetermined AP (Access Point), however, it is quite within the bounds of possibility that information is tapped at the AP or the speed of transmission decreases. In such a case, it is thus desirable to have the PC 1 exchange information with the SP server 3 through only the public network 2, by-passing the AP.

Furthermore, in this embodiment, an IP server 5, a computer 6, a FAX-information providing apparatus 7, a telephone set 8, a host computer 9 and a voice-mail handling apparatus 10 each serve as a communication apparatus carrying out communication with the PC 1 only through the public network 2 as described above. It is worth noting, however, that the present invention can also be applied to other kinds of communication apparatus as well.

What is claimed is:

1. A recording medium for recording information described in a language usable for describing a link destination wherein said information includes a line number assigned to a line connected to a predetermined apparatus as a link destination.

2. A recording medium according to claim 1 wherein said information is described in an HTML (Hyper Text Markup Language) and said line number is described along with a line-number tag, a tag for showing that what is described thereby is a line number.

3. A recording medium according to claim 1 wherein a communication method for communicating with said predetermined apparatus is also described along with said line number.

4. A transmission medium for transmitting information described in a language usable for describing a link destination wherein said information includes a line number assigned to a line connected to a predetermined apparatus as a link destination.

5. A transmission medium according to claim 4 wherein said information is described in an HTML (Hyper Text Markup Language) and said line number is described along with a line-number tag, a tag for showing that what is described thereby is a line number.

6. A transmission medium according to claim 4 wherein a communication method for communicating with said predetermined apparatus is also described along with said line number.

7. An information processing apparatus for processing incoming information described in a language usable for describing a link destination, said apparatus comprising:
a receiving means for receiving said information transmitted by an information providing apparatus for providing said information;
a display means for displaying said information received by said receiving means;
a command operation means to be operated when specifying a predetermined position in said information displayed by said display means; and
a communication control means which is used for establishing a communication link with a predetermined apparatus based on a line number assigned to a line connected to said predetermined apparatus if said predetermined position specified by operating said command operation means is associated with said line number.

8. An information processing apparatus according to claim 7 wherein:
said information is described in an HTML (Hyper Text Markup Language);
said line number is described along with a line-number tag, a tag for showing that what is described thereby is a line number; and
a recognition means is employed thereby for forming a judgment as to whether or not said line number is associated with said predetermined position based on said line-number tag.

9. An information processing apparatus according to claim 7 wherein:
a communication method for communicating with said predetermined apparatus is also described along with said line number; and
said communication control means establishes a communication link with said predetermined apparatus in accordance with said communication method described along with said line number.

10. An information processing apparatus according to claim 7 further including a line-number selecting means which is used for selecting one from a plurality of line numbers in case said line numbers are associated with said predetermined position.

11. An information processing apparatus according to claim 7 further including a number adding means which is used for adding a number required for international communication to a line number in case said line number is a line number of a foreign country.

12. An information processing apparatus according to claim 7 further including a confirmation operating means to be operated for confirming that a communication link with said predetermined apparatus shall be established.

13. An information processing apparatus according to claim 7 wherein said display means also displays an estimated charge for a telephone call to communicate with said predetermined apparatus.

14. An information processing apparatus according to claim 7 wherein:
said receiving means receives said information transmitted by said information providing apparatus by way of a predetermined network after a communication link connecting said information processing apparatus to said predetermined network has been established;
said communication control means establishes a communication link connecting said information processing apparatus to said predetermined apparatus after a line connecting said information processing apparatus to said predetermined network has been cut off; and
said communication link connecting said information processing apparatus to said predetermined network is reestablished after communication with said predetermined apparatus has been completed.

15. An information processing apparatus according to claim 7 wherein:
said receiving means receives said information transmitted by said information providing apparatus by way of a predetermined network after a communication link connecting said information processing apparatus to said predetermined network has been established; and
in case an attempt made by said communication control means to establish a communication link connecting said information processing apparatus to said predetermined apparatus after cutting off a line connecting said information processing apparatus to said predetermined network ends in a failure, either an attempt to establish a communication link connecting said information processing apparatus to said predetermined apparatus is again made or said communication link connecting said information processing apparatus to said predetermined network is re-established.

16. An information processing apparatus according to claim 15 wherein, in case said attempt made by said communication control means to establish a communication link connecting said information processing apparatus to said predetermined apparatus ends in a failure, said information processing apparatus is capable of selecting either processing to again make an attempt to establish a communication link connecting said information processing apparatus to said predetermined apparatus or processing to re-establish said communication link connecting said information processing apparatus to said predetermined network.

17. An information processing method for processing incoming information described in a language usable for describing a link destination, said method comprising the steps of:
receiving and displaying said information transmitted by an information providing apparatus for providing said information; and
establishing a communication link with a predetermined apparatus based on a line number assigned to a line connected to said predetermined apparatus if a predetermined position on said displayed information is indicated and said predetermined position is associated with said line number.

18. A recording medium for storing a computer program to be executed by an information processing apparatus for processing incoming information described in a language usable for describing a link destination, said program comprising the steps of:
receiving and displaying said information transmitted by an information providing apparatus for providing said information; and
establishing a communication link connecting said information processing apparatus to a predetermined apparatus based on a line number assigned to a line connected to said predetermined apparatus if a predetermined position on said displayed information is indicated and said predetermined position is associated with said line number.

19. A transmission medium for transmitting a computer program to be executed by an information processing apparatus for processing incoming information described in a language usable for describing a link destination, said program comprising the steps of:
receiving and displaying said information transmitted by an information providing apparatus for providing said information; and
establishing a communication link connecting said information processing apparatus to a predetermined apparatus based on a line number assigned to a line connected to said predetermined apparatus if a predetermined position on said displayed information is indicated and said predetermined position is associated with said line number.

20. An information providing apparatus comprising:
a recording medium for storing information described in a language usable for describing a link destination; and
a transmitting means for transmitting said information in response to a request,
wherein said information stored in said recording medium includes a line number assigned to a line connected to a predetermined apparatus as said link destination.

21. An information providing apparatus according to claim 20 wherein:
said information is described in a HTML (Hyper Text Markup Language); and
said line number is described along with a line-number tag for indicating that a description thereof is a line number.

22. An information providing apparatus according to claim 20 wherein a communication method for communicating with said predetermined apparatus is described along with said line number.

23. An information processing system comprising an information providing apparatus for providing information described in a language usable for describing a link destination and an information processing apparatus for receiving and processing said information wherein:
said information providing apparatus comprises:
a recording medium for storing information including a line number assigned to a line connected to a predetermined apparatus as said link destination; and
a transmitting means for transmitting said information in response to a request received from said information processing apparatus,
whereas said information processing apparatus comprises:
a receiving means for receiving said information transmitted by said information providing apparatus;
a display means for displaying said information received by said receiving means;
a command operation means to be operated when specifying a predetermined position in said information displayed by said display means; and
a communication control means which is used for establishing a communication link connecting said information processing apparatus to a predetermined apparatus based on a line number assigned to a line connected to said predetermined apparatus if said predetermined position specified by operating said command operation means is associated with said line number.
